(19) United States
(12) Patent Application Publication
(10) Pub. No.: US 2012/0116891 A1
(43) Pub. Date: May 10, 2012

(54) Systems and Methods for Matching Complementary Risk Profiles to Enhance Digital Ad Delivery

(75) Inventor: Hastagiri Prakash, Bangalore (IN)

(73) Assignee: Yahoo! Inc., Sunnyvale, CA (US)

(21) Appl. No.: 12/942,230

(22) Filed: Nov. 9, 2010

(51) Int. Cl. G06Q 30/00

(52) U.S. Cl. 705/14.69; 705/14.73

(57) ABSTRACT

Systems and methods for matching complementary risk profiles to enhance digital ad delivery are disclosed. Generally, a model is generated to determine a risk profile associated with an advertiser or a publisher. After receipt of a digital ad request, a risk profile of an advertiser is determined based on the model and a risk profile of a publisher is determined based on the model. A determination is made whether to serve a digital ad associated with the advertiser for display on a webpage associated with the publisher based on the risk profile associated with the advertiser and the risk profile associated with the publisher. The digital ad is served for display on the webpage in response to determining the risk profile associated with the advertiser compliments the risk profile associated with the publisher.

### BACKGROUND

Online advertisers may normally purchase digital ads based on a guaranteed or a non-guaranteed basis. When an advertiser purchases a digital ad based on a guaranteed basis, the advertiser agrees to pay a fix amount for a defined number of events, such as impressions, clicks, leads, or acquisitions. However, when an advertiser purchases a digital ad based on a non-guaranteed basis, the advertiser purchases digital ads based on an auction model where the advertiser competes against other advertisers to have their digital ad displayed on a webpage. Similarly, publishers may sell ad space on webpages to display digital ads of advertisers. Publishers may also be compensated for displaying a digital ad on a webpage based on impressions, clicks, leads, and/or acquisitions associated with displayed digital ads.

Due to the different pricing mechanisms for advertisers and publishers, online advertisement providers (ad providers) often determine which digital ad to display on a webpage based on an effective cost-per-thousand impressions (eCPM) of a digital ad. Accordingly, it would be desirable to develop improved methods for determining which digital ad to display on a webpage based on the different pricing mechanisms available to advertisers and publishers.

### BRIEF DESCRIPTION OF THE DRAWINGS

FIG. 1 is a block diagram of an environment in which systems for matching complementary risk profiles to enhance digital ad delivery may operate;

FIG. 2 is a block diagram of a system for matching complementary risk profiles to enhance digital ad delivery;

FIG. 3 is a flow chart of a method for building a model for predicting a risk profile associated with advertisers or publishers; and

FIG. 4 is a flow chart of a method for matching complementary risk profiles to enhance digital ad delivery.

### DETAILED DESCRIPTION OF THE DRAWINGS

The present disclosure is directed to methods and system for matching complementary risk profiles to enhance digital ad delivery. Generally, an ad provider develops models to predict a risk profile associated advertisers and publishers. As explained in more detail below, when the ad provider receives a digital ad request from a publisher, the ad provider serves a digital ad from an advertiser with a risk profile that complements a risk profile of the publisher. In some implementations, the ad provider attempts to match publishers associated with a high-risk profile with advertisers associated with a low-risk profile and the ad provider attempts to match publishers associated with a low-risk profile with advertisers associated with a high-risk profile.

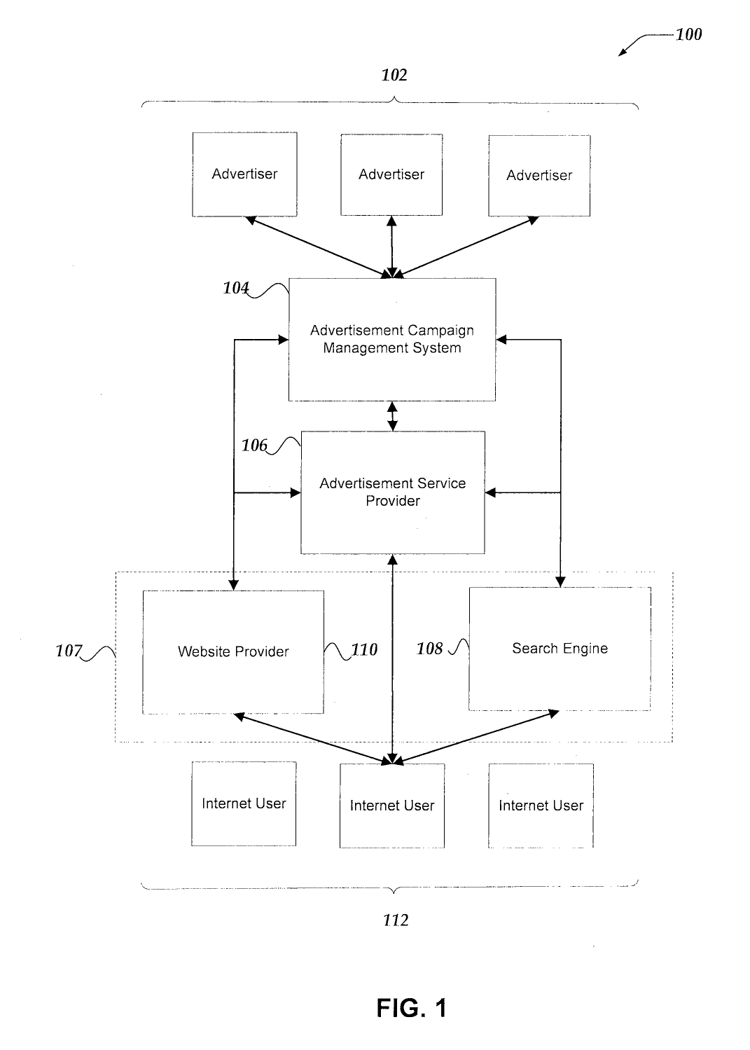

FIG. 1 is a block diagram of an environment in which systems for matching complementary risk profiles to enhance digital ad delivery may operate. The environment 100 may include a plurality of advertisers 102, an ad campaign management system 104, an ad provider 106, publishers 107 such as a search engine 108 and a website provider 110, and a plurality of users 112.

Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may select—and possibly pay additional premiums for—certain targeting options, such as targeting by demographics, geography, behavior (such as past purchase patterns), “social technographics” (degree of participation in an online community) or context (page content, time of day, navigation path, etc.). The digital ad may be a graphical ad that appears on a website viewed by a user 112, a sponsored search listing that is served to a user 112 in response to a search performed at a search engine, a video ad, a graphical banner ad based on a sponsored search listing, and/or any other type of online marketing media known in the art.

When a user 112 performs a search at a search engine 108, the search engine 108 typically receives a search query comprising one or more keywords. In response to the search query, the search engine 108 returns search results including one or more search listings based on keywords within the search query provided by the user 112. Additionally, the ad provider 106 may receive a digital ad request based on the received search query. In response to the digital ad request, the ad provider 106 serves one or more digital ads created using the ad campaign management system 104 to the search engine 108 and/or the user 112 based on keywords within the search query provided by the user 112.

Similarly, when a user 112 requests a webpage served by the website provider 110, the ad provider 106 may receive a digital ad request. The digital ad request may include data such as keywords obtained from the content of the webpage. In response to the digital ad request, the ad provider 106 serves one or more digital ads created using the ad campaign management system 104 to the website provider 110 and/or the user 112 based on the keywords within the digital ad request.

When the digital ads are served, the ad campaign management system 104 and/or the ad provider 106 may record and process information associated with the served digital ads for purposes such as billing, reporting, or ad campaign optimization. For example, the ad campaign management system 104 and/or the ad provider 106 may record the factors that caused the ad provider 106 to select the served digital ads; whether the user 112 clicked on a URL or other link associated with one of the served digital ads; what additional search listings or digital ads were served with each served digital ad; a position on a webpage of a digital ad when the user 112 clicked on a digital ad; and/or whether the user 112 clicked on a different digital ad when a digital ad was served. One example of an ad campaign management system that may perform these types of actions is disclosed in U.S. patent application Ser. No. 11/413,514, filed Apr. 28, 2006, and assigned to Yahoo! Inc.

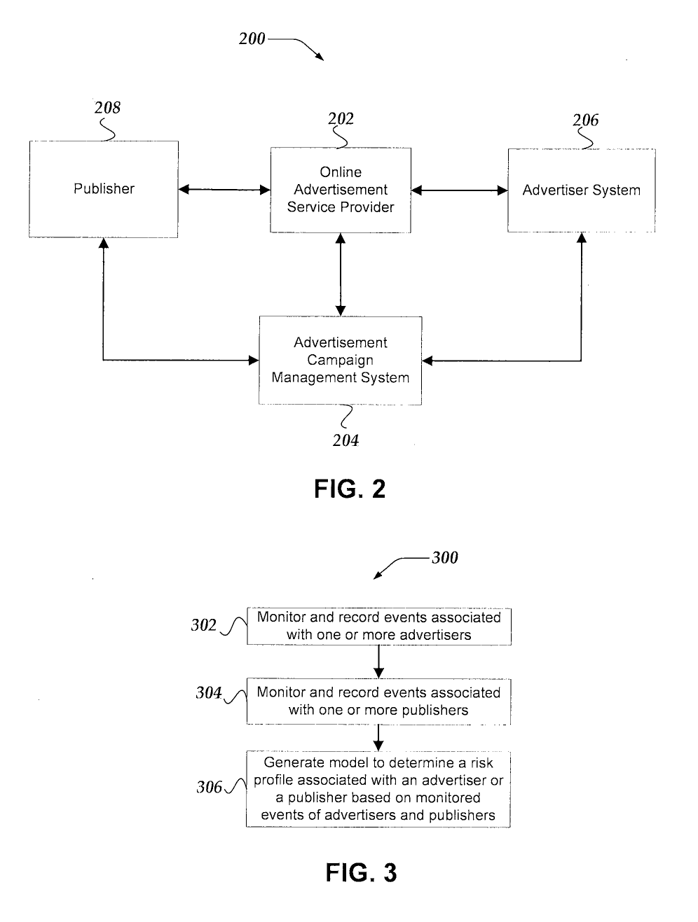

FIG. 2 is a block diagram of a system for matching complementary risk profiles to enhance digital ad delivery. Generally, the system 200 may include an ad provider 202, an ad campaign management system 204, an advertiser system 206 (also referred to below as an advertiser), and a publisher 208 such as a website provider or a search engine. In some implementations the ad campaign management system 204 may be part of the ad provider 202, where in other implementations, the ad campaign management system 204 is distinct from the ad provider 202.

The ad provider 202, ad campaign management system 204, advertiser system 206 and publisher 208 may communicate with each other over one or more external or internal networks. The networks may include local area networks (LAN), wide area networks (WAN), and/or the Internet, and may be implemented with wireless or wired communication mediums such as wireless fidelity (WiFi), Bluetooth, landlines, satellites, and/or cellular communications. Further, the ad provider 202, ad campaign management system 204, advertiser system 206 and publisher 208 may be implemented as software code or instructions that may be stored in a tangible computer-readable storage medium, and be executed by one or more hardware processors of a single server, plurality of servers, or any other type of computing device known in the art.

Generally, the ad provider 202 and/or ad campaign management system 204 monitor and record events associated with the advertisers 206 and/or publishers 208, such as advertiser 206 and/or publisher 208 interactions with the ad provider 202 and/or ad campaign management system 208. For example, the ad provider 202 and/or ad campaign management system 204 may monitor and record whether advertisers 206 purchase digital ads based on a guaranteed or non-guaranteed basis. Additionally, the ad provider 202 and/or ad campaign management system 204 may monitor and record which pricing mechanism advertisers 206 choose, such as agreeing to pay for a defined number of impressions, clicks, leads, or acquisitions or agreeing to pay for digital ads per impression, click, lead, and/or acquisition. The ad provider 202 and/or ad campaign management system 204 may further monitor and record ad campaign information such as goals, bid amounts, keywords, optimization settings, ad quality scores, or any other information that an advertiser may associate with an ad campaign.

Similarly, the ad provider 202 and/or ad campaign management system 204 may monitor and record whether publishers agree to provide ad space on webpages based on a guaranteed or non-guaranteed basis. Additionally, the ad provider 202 and/or ad campaign management system 204 may monitor and record which pricing mechanism publishers agree to provide ad space on, such as agreeing to provide ad space based on impressions, clicks, leads, and/or acquisitions.

The ad provider 202 and/or ad campaign management system 204 may perform operations such as a regression analysis or machine learning techniques on the monitored and recorded events to generate a model to determine a risk profile associated with an advertiser or a publisher. A conversion funnel for conversions associated with digital ads is typically illustrated according to the state diagram: impression→click→lead→acquisition/purchase. Advertisers 206 typically make money when an acquisition/purchase takes place. Accordingly, due to the higher probability of a customer completing an acquisition/purchase as one moves from left to right across the events of the conversion funnel, it will be appreciated that a risk to an advertiser 206 decreases as one moves from left to right across the events of the conversion funnel. For example, because a lead is more likely to lead to an acquisition/purchase than an impression, an advertiser 206 assumes a greater risk when paying for a digital ad on a per impression basis than when paying for a digital ad on a per lead basis. However, to compensate for the decrease in risk to the advertiser 206 and an increase in risk to the publisher 208 as one moves from left to right across the events of the conversion funnel, publishers 208 often charge premiums for displaying digital ads on the basis of events closer to an acquisition/purchase.

As discussed above, publishers 208 may agree to display digital ads based on different pricing mechanisms, such as displaying digital ads based on impressions, clicks, leads, and/or acquisitions/purchases. Due to the low probabilities of a potential customer proceeding through the events of the conversion funnel to complete an acquisition/purchase, it may often take a number of occurrences of one event associated with a digital ad in the conversion funnel before the occurrence of a next subsequent event associated with the digital ad in the conversion funnel. For example, a publisher 208 may need to display a digital ad a number of times (an impression) before an online user clicks on the digital ad. Similarly, it may take a number of online users clicking on a digital ad before an online user generates a lead associated with the digital ad. Accordingly, it will be appreciated that as one moves from left to right across the events of the state diagram, a risk to a publisher 208 increases as a publisher 208 agrees to display digital ads based on events closer to the purchase/acquisition state. For example, because it may take many impressions and clicks associated with a digital ad before an online user generates a lead associated with the digital ad, a publisher 208 assumes more risk displaying a digital ad on a per lead basis than displaying a digital ad on a per impression basis.

In order to more efficiently serve digital ads, when an ad provider 202 receives a digital ad request from a publisher 208, the ad provider 202 and/or ad campaign management system 204 utilizes the model to attempt to match a digital ad associated with an advertiser 206 that has a risk profile that complements a risk profile of the publisher 208. As explained in more detail below, the ad provider 202 and/or ad campaign management system 204 may attempt to match a publisher 208 willing to assume a high risk with an advertiser 206 willing to assume a low risk, or the ad provider 202 and/or ad campaign management system 204 may attempt to match a publisher 208 willing to assume a low risk with an advertiser 206 will the assume a high risk.

For example, when an ad provider 202 receives a digital ad request from a publisher 208 that has agreed to display digital ads on a per impression basis (low risk), the ad provider 202 and/or ad campaign management system 204 may utilize the model to attempt to match the digital ad request with a digital ad associated with an advertiser 206 that has purchased digital ads on a per impression basis (high risk). Similarly, when an ad provider 202 receives a digital ad request from a publisher 208 that has agreed to display digital ads on a per lead basis (high risk), the ad provider 202 and/or ad campaign management system 204 may utilize the model to attempt to match the digital ad request with a digital ad associated with an advertiser 206 that has purchased digital ads on a per lead basis (low risk).

Otherwise, it will be appreciated that a situation may occur where an ad provider 202 serves a digital ad in response to a digital ad request where a publisher 208 has agreed to display digital ads on a per impression basis (low risk) and the advertiser has purchased digital ads on a per lead basis (low risk). If the impression of the digital ad does not result in a lead, the ad provider 202 will be required to compensate the publisher 208 for displaying the digital ad, but the advertiser 206 will not compensate the ad provider 202 for displaying the digital ad.

In one implementation, a risk profile of an advertiser may be defined as a vector including values {m_{1,2}(v_{1,2}) m_{2,3}(v_{2,3}), . . . m_{n-1,n}(v_{n-1,n}) } and a risk profile of a publisher may be defined as a vector including values {d_{1,2}(v_{1,2}), d_{2,3}(v_{2,3}), d_{n-1,n}(v_{n-1,n})}, where n is a total number of state events in a conversion funnel. With respect to the risk profile of an advertiser 206, vᵢ is a variance in the number of events in state i before state j, and m_{i,j}, which is a function of variance, is a markup in payment that an advertiser is willing to pay between state i and state j. For example, in the illustrative conversion funnel above, m_{1,2} is a markup in payment associated with an advertiser between an impression and a click, and v_{1,2} is a variance in the number of events that occur between an impression and a click.

With respect to the risk profile of a publisher 208, v_{i,j} is a variance in the number of events in state i before state j, and d_{i,j} which is a function of variance, is a markup in price due to demand by a publisher 208 for producing an event in state j rather than an event in state i. For example, in the illustrative conversion funel above, d_{2,3} is a markup in price due to demand by a publisher 208 for producing a lead rather than a click, and v_{2,3} is a variance in the number of events that occur between a click and a lead.

Using these vectors, when an ad provider 202 receives a digital ad request from a publisher 208 that accepts more than one pricing mechanisms, the ad provider 202 may attempt to select a pricing mechanism and a digital ad associated with an advertiser 206 based on factors such as a difference between a risk profile associated with the publisher 208 and a risk profile associated with an advertiser 206. Using the risk profile expressions described above, the ad provider 202 may accomplish this by maximizing a difference between m_{i,j}(v_{i,j}) and d_{i,j}(v_{i,j}).

Further, when an ad provider 202 receives a digital ad request from a publisher 208 accepting only one pricing mechanism, the ad provider 202 may select a digital ad associated with an advertiser 206 willing to purchase digital ads in that particular pricing mechanism based on factors such as a difference between a risk profile associated with the publisher 208 and a risk profile associated with an advertiser 206. Using the risk profile expressions described above, the ad provider 202 may accomplish this by maximizing a difference between m_{i,j}(v_{i,j}) and d_{i,j}(v_{i,j}).

It will be appreciated that an ad provider 202 may utilize factors such as a difference between a risk profile associated with the publisher 208 and a risk profile associated with an advertiser 206 in conjunction with other factors such as eCPM in selecting a digital ad to serve to a publisher 208 in response to a digital ad request.

FIG. 3 is a flow chart of a method for building a model for predicting a risk profile associated with advertisers or publishers. The method 300 begins at step 302 with an ad provider and/or ad campaign management system monitoring and records events associated with one or more advertisers. Similarly, at step 304, the ad provider and/or ad campaign management system monitors and records events associated with one or more publishers.

As described above, the ad provider and/or ad campaign management system may monitor and record, for example, whether advertisers purchase digital ads based on a guaranteed or non-guaranteed basis. Additionally, the ad provider and/or ad campaign management system may monitor and record which pricing mechanism advertisers choose, such as agreeing to pay for a defined number of impressions, clicks, leads, or acquisitions or pay for an digital ad per impression, per click, per lead, and/or per acquisition. The ad provider and/or ad campaign management system may further monitor and record ad campaign information such as goals, bid amounts, keywords, optimization settings, ad quality scores, or any other information that an advertiser may associate with an ad campaign. Similarly, the ad provider and/or ad campaign management system may monitor and record whether publishers agree to provide ad space on webpages based on a guaranteed or non-guaranteed basis. Additionally, the ad provider and/or ad campaign management system may monitor and record which pricing mechanism publishers agree to provide ad space on, such as agreeing to provide ad space based on impressions, clicks, leads, or acquisitions.

At step 306, the ad provider and/or ad campaign management system generates a model to predict a risk profile associated with an advertiser or a publisher based on the monitored events of the one or more advertisers and the one or more publishers. In some implementations, the ad provider and/or ad campaign management system generate the model using regression analysis or machine learning techniques.

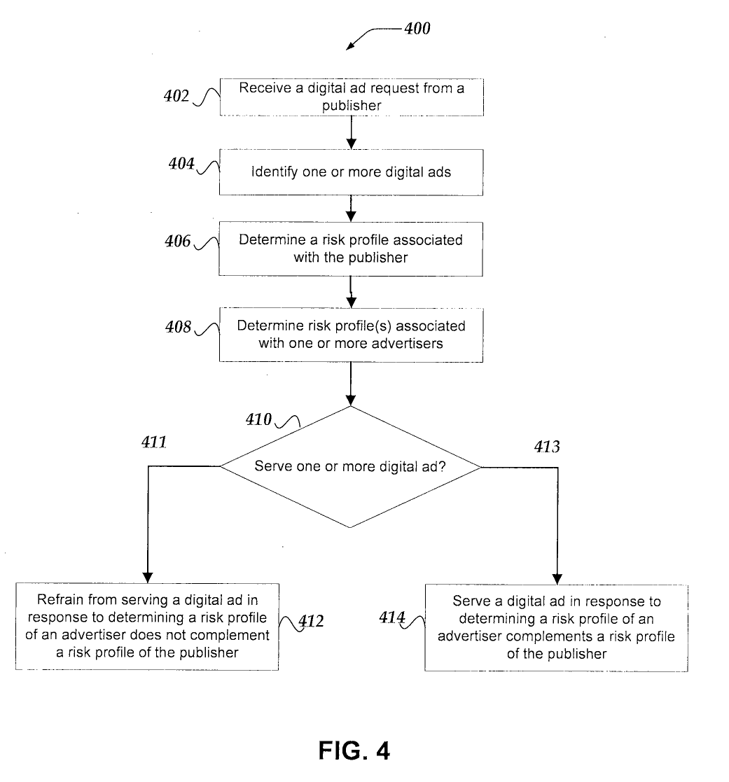

FIG. 4 is a flow chart of a method for matching complementary risk profiles to enhance digital ad delivery using a model such as the model described above with respect to FIG. 3. The method 400 begins at step 402 with an ad provider receiving a digital ad request from a publisher. The ad provider may receive the request for the digital ad based on, for example, terms in a search query that a user submits to a search engine or terms from the content of a webpage that a user requests.

At step 404, the ad provider and/or ad campaign management system identifies one or more digital ads that may potentially be served in response to the digital ad request. It will be appreciated that the ad provider and/or ad campaign management system may identify the digital ads based on, for example, keywords received with the digital ad request, an eCPM associated a digital ad, and/or a pricing mechanism associated with a digital ad.

At step 406, the ad provider and/or ad campaign management system determines a risk profile associated with the publisher based on a model such as the model described above with respect to FIG. 3. At step 408, the ad provider and/or ad campaign management system determines a risk profile associated with one or more advertisers that are associated with the digital ads identified in step 404 based on a model such as the model described above with respect to FIG. 3.

At step 410, the ad provider and/or ad campaign management system determines whether to serve one or more of the digital ads identified at step 404 based on the risk profile associated with the publisher and the risk profile(s) associated with the one or more advertisers. If the risk profile of an advertiser associated with a digital ad does not complement the risk profile of the publisher (branch 411), the ad provider and/or ad campaign management system may refrain from serving the digital ad at step 412. However, if the risk profile of an advertiser associated with a digital ad complements the risk profile of the publisher (branch 413), the ad provider and/or ad campaign management system may determine to serve the digital ad at step 414. In some implementations, a risk profile of a publisher complements a risk profile of an advertiser if the publisher agrees to display a digital ad based on the same pricing mechanism and/or event in a conversion funnel that the advertiser agrees to purchases a digital ad on. In other implementations, a risk profile of a publisher complements a risk profile of an advertiser if the publisher agrees to display a digital ad based on a first event in a conversion funnel that is within a defined number of events of a second event in the conversion funnel that the advertiser has agreed to purchase a digital ad on.

As discussed above, when determining whether to serve a digital ad, the ad provider and/or the ad campaign management system may attempt to match a publisher associated with a high-risk profile with advertisers associated with a low-risk profile, or the ad provider and/or the ad campaign management system may attempt to match a publisher associated with a low-risk profile with advertisers associated with a high-risk profile. Additionally, when determining whether to serve a digital ad, the ad provider and/or ad campaign management system may attempt to maximize a difference between a markup in price that an advertiser is willing to pay between two states in a conversion funnel and a markup in price due to demand charged by a publisher between two states in a conversion funnel, express above as a difference between m_{i,j}(v_{i,j}) and d_{i,j}(v_{i,j}).

FIGS. 1-4 disclose systems and methods for matching complementary risk profiles to enhance digital ad delivery. As discussed above, an ad provider and/or an ad campaign management system develops models to predict a risk profile associated advertisers and publishers. When the ad provider receives a digital ad request from a publisher, the ad provider serves a digital ad from an advertiser with a risk profile that complements a risk profile of the publisher. In some implementations, the ad provider attempts to match publishers associated with a high-risk profile with advertisers associated with a low-risk profile and the ad provider attempts to match publishers associated with a low-risk profile with advertisers associated with a high-risk profile.

It is intended that the foregoing detailed description be regarded as illustrative rather than limiting, and that it be understood that it is the following claims, including all equivalents, that are intended to define the spirit and scope of this invention.

1. A method for serving a digital ad, the method comprising:
generating a model to determine a risk profile associated with an advertiser or a publisher based on monitored events associated with one or more advertisers and one or more publishers;
determining a risk profile associated with an advertiser based on the model;
determining a risk profile associated with a publisher based on the model;
determining whether to serve a digital ad associated with the advertiser for display on a webpage associated with the publisher based on the risk profile associated with the advertiser and the risk profile associated with the publisher; and
serving the digital ad for display on the webpage in response to determining the risk profile associated with the advertiser compliments the risk profile associated with the publisher.

2. The method of claim 1, further comprising:
monitoring events associated with one or more advertisers; and
monitoring events associated with one or more publishers.

3. The method of claim 2, wherein the monitored events associated with the one or more advertisers comprise pricing mechanisms associated with digital ads of the one or more advertiser.

4. The method of claim 2, wherein the monitored events associated with the one or more publishers comprise pricing mechanisms associated with ad space of the one or more publishers.

5. The method of claim 1, wherein the model is generated based on a regression analysis.

6. The method of claim 1, wherein the model is generated based on machine learning techniques.

7. The method of claim 1, wherein determining whether to serve a digital ad associated with the advertiser for display on a webpage associated with the publisher based on the risk profile associated with the advertiser and the risk profile associated with the publisher comprises:
determining whether to serve the digital ad for display on the webpage based on a difference between a markup in price that the advertiser is willing to pay between two states in a conversion funnel and a markup in price charged by the publisher between two states in the conversion funnel.

8. The method of claim 1, wherein determining a risk profile associated with an advertiser based on the model comprises determining that the advertiser is a high-risk advertiser; and
wherein determining a risk profile associated with a publisher based on the model comprises determining that the publisher is a low-risk publisher.

9. The method of claim 1, wherein determining a risk profile associated with an advertiser based on the model comprises determining that the advertiser is a low-risk advertiser; and
wherein determining a risk profile associated with a publisher based on the model comprises determining that the publisher is a high-risk publisher.

10. The method of claim 1, further comprising:
refraining from serving the digital ad for display on the webpage in response to determining the risk profile associated with the advertiser does not compliment the risk profile associated with the publisher.

11. A computer-readable storage medium comprising a set of instructions for serving a digital ad, the set of instructions to direct a processor to perform acts of:
generating a model to determine a risk profile associated with an advertiser or a publisher based on monitored events associated with one or more advertisers and one or more publishers;
determining a risk profile associated with an advertiser based on the model;
determining a risk profile associated with a publisher based on the model;
determining whether to serve a digital ad associated with the advertiser for display on a webpage associated with the publisher based on the risk profile associated with the advertiser and the risk profile associated with the publisher; and
serving the digital ad for display on the webpage in response to determining the risk profile associated with the advertiser compliments the risk profile associated with the publisher.

12. The computer-readable storage medium of claim 11, wherein determining whether to serve a digital ad associated with the advertiser for display on a webpage associated with the publisher based on the risk profile associated with the advertiser and the risk profile associated with the publisher comprises:
determining whether to serve the digital ad for display on the webpage based on a difference between a markup in price that an advertiser is willing to pay between two states in a conversion funnel and a markup in price charged by a publisher between two states in the conversion funnel.

13. The computer-readable storage medium of claim 11, wherein determining a risk profile associated with an advertiser based on the model comprises determining that the advertiser is a high-risk advertiser; and
wherein determining a risk profile associated with a publisher based on the model comprises determining that the publisher is a low-risk publisher.

14. The computer-readable storage medium of claim 11, wherein determining a risk profile associated with an advertiser based on the model comprises determining that the advertiser is a low-risk advertiser; and
wherein determining a risk profile associated with a publisher based on the model comprises determining that the publisher is a high-risk publisher.

15. The computer-readable storage medium of claim 14, wherein the computer-readable storage medium further comprises a set of instructions to direct a processor to perform acts of:
refraining from serving the digital ad for display on the webpage in response to determining the risk profile associated with the advertiser does not compliment the risk profile associated with the publisher.

16. A system for serving digital ads, the system comprising:
a server comprising a memory storing a set of instructions and one or more processors configured to execute the set of instructions stored in the memory, the server configured to:
generate a model to determine a risk profile associated with an advertiser or a publisher based on monitored events associated with one or more advertisers and one or more publishers;
determine a risk profile associated with an advertiser based on the model;
determine a risk profile associated with a publisher based on the model;
determine whether to serve a digital ad associated with the advertiser for display on a webpage associated with the publisher based on the risk profile associated with the advertiser and the risk profile associated with the publisher; and
serve the digital ad for display on the webpage in response to determining the risk profile associated with the advertiser compliments the risk profile associated with the publisher.

17. The system of claim 16, wherein to determine whether to serve a digital ad associated with the advertiser for display on a webpage associated with the publisher based on the risk profile associated with the advertiser and the risk profile associated with the publisher, the server is further configured to:
determining whether to serve the digital ad for display on the webpage based on a difference between a markup in price that an advertiser is willing to pay between two states in a conversion funnel and a markup in price charged by a publisher between two states in the conversion funnel.

18. The system of claim 16, wherein to determine a risk profile associated with an advertiser based on the model, the server is further configured to determine that the advertiser is a high-risk advertiser; and
wherein to determine a risk profile associated with a publisher based on the model, the server is further configured to determine that the publisher is a low-risk publisher.

19. The system of claim 16, wherein to determine a risk profile associated with an advertiser based on the model, the server is further configured to determine that the advertiser is a low-risk advertiser; and
wherein to determine a risk profile associated with a publisher based on the model, the server is further configured to determine that the publisher is a high-risk publisher.

20. The system of claim 16, wherein the server is further configured to refrain from serving the digital ad for display on the webpage in response to determining the risk profile associated with the advertiser does not compliment the risk profile associated with the publisher.
